(19) United States
(12) Patent Application Publication
(10) Pub. No.: US 2007/0022035 A1
(43) Pub. Date: Jan. 25, 2007

(54) System and method for continuous sale or transfer of employee stock options

(76) Inventors: David A. Seaman, Short Hills, NJ (US); Santosh V. Nabar, Englewood, NJ (US)

Correspondence Address: MILBANK, TWEED, HADLEY & MCCLOY, 1 CHASE MANHATTAN PLAZA, NEW YORK, NY, 10005-1413, US

(21) Appl. No.: 11/258,408

(22) Filed: Oct. 25, 2005

Related U.S. Application Data
(60) Provisional application No. 60/701,350, filed on Jul. 21, 2005.

(51) Int. Cl. G06Q 40/00

(52) U.S. Cl. 705/36 R; 705/37

(57) ABSTRACT

A company provides options to an employee on stock of the company at a first time, the options comprising at least a strike price, a maturity date, a vesting requirement and a restriction on transfer. At a second time that is after the first time, the company provides a registration statement and a prospectus, the registration statement and the prospectus covering sale or transfer of the options from the employee to a third party.

This application claims priority to U.S. Provisional Patent Application Ser. No. 60/701,350, filed Jul. 21, 2005, entitled SYSTEM AND METHOD FOR SALE OF EMPLOYEE STOCK OPTIONS, the disclosure of which is incorporated herein by reference.

### BACKGROUND

The invention relates to the field of securities, and more particularly to the field of transferable employee stock options.

Companies frequently issue employee stock options. However, these options generally include restrictions on sale or transfer, and the restrictions impact the option value. Systems and methods are needed to provide for sale or transfer of employee stock options.

The preceding description is not to be construed as an admission that any of the description is prior art relative to the present invention.

### SUMMARY OF THE INVENTION

The various aspects of the embodiments provide a system and method for sale or transfer of employee stock options. The system and method comprise providing options to an employee on stock of an issuing company at a first time, the options comprising at least a strike price, a maturity date, a vesting requirement and a restriction on transfer. The system and method further comprise providing a registration statement and a prospectus at a second time that is after the first time, the registration statement and the prospectus covering sale or transfer of the options from the employee to a third party.

In another aspect, the system and method further comprise providing information on the options to bidders in a market, the information comprising strike price, maturity date and number of options. In another aspect, the system and method further comprise receiving bid information on the options, and making the bid information available to the employee. In one aspect, the bid information comprises price. In one aspect, the bid information comprises size. In one aspect, the bid information comprises market depth. In another aspect, the system and method further comprise receiving an order from the employee to sell or transfer at least some of the options, executing at least part of the order, and providing order execution information to the employee. In one aspect, the order is a market order to sell. In one aspect, the order is a limit order to sell. In one aspect, the order comprises number of options to sell. In one aspect, executing the order is in priority by price. In another aspect, the system and method further comprise maintaining information on the options, selling or transferring some of the options to the third party, and updating the information on the options after the employee sells or transfers some of the options. In one aspect, the information on the options comprises number of vested options and strike prices of the options. In another aspect, the system and method further comprise delivering the prospectus to the third party. In another aspect, the system and method further comprise providing information to the employee on options held by the employee. In another aspect, the system and method further comprise providing information to the employee on options eligible for sale or transfer by the employee. In another aspect, the system and method further comprise receiving at least some of the options from the employee; and providing transferable stock options to the third party. In another aspect, the system and method further comprise selling or transferring at least some of the options to the third party, withholding tax from proceeds of the sale or transfer, and providing a balance to the employee in cash or shares. In another aspect, the system and method further comprise amending terms of previously issued options to allow sale or transfer of the previously issued options to the third party. In one aspect, the options further comprise a lapse restriction, the system and method further comprising: removing the lapse restriction after sale or transfer of the options to the third party. In one aspect, the registration statement is a Securities and Exchange Commission registration statement. In one aspect, the options include a provision for net share settlement upon exercise by the third party. In one aspect, the registration statement and prospectus cover options sold or transferred to the third party. In one aspect, the registration statement and prospectus cover common stock sold or transferred to the third party and underlying the options.

The foregoing specific aspects are illustrative of those which can be achieved and are not intended to be exhaustive or limiting of the possible advantages that can be realized. Thus, the objects and advantages will be apparent from the description herein or can be learned from practicing the invention, both as embodied herein or as modified in view of any variations which may be apparent to those skilled in the art. Accordingly, the present invention resides in the novel parts, constructions, arrangements, combinations and improvements herein shown and described.

### BRIEF DESCRIPTION OF THE DRAWINGS

The foregoing features and other aspects of the invention are explained in the following description taken in conjunction with the accompanying figures wherein:

FIG. 1 illustrates a system according to one embodiment;

FIG. 2 illustrates steps in a method according to one embodiment; and

FIG. 3 illustrates valuation of an employee stock option without the invention.

It is understood that the drawings are for illustration only and are not limiting.

### DETAILED DESCRIPTION OF THE DRAWINGS

As more fully described below, a company provides an effective SEC registration statement and prospectus during periodic windows, which allow an employee to sell or transfer options on the company stock to third parties, and for the third parties to then freely hedge the purchased or transferred options. In some instances, the options are transferred from the employee to the third party, with assistance from the company, which provides the effective registration statement and prospectus. In other instances, the employee transfers their options to the issuing company and the issuing company provides transferable stock options to the third party, with the effective registration statement and prospectus available for hedging the purchased of the transferable stock options.

Companies grant employee stock options (ESOs) to employees and management. These ESOs are typically fixed strike call options with a set maturity that are issued by the employer or company, and are subject to vesting and other restrictions. One significant restriction is that ESOs may not be resold, transferred, pledged or hedged, which limits and reduces the value of the ESOs relative to a pure Black-Scholes or other option model value of an unrestricted option. Because ESOs are subject to vesting, are not freely tradable, and are held by less than perfectly diversified employees, employees tend to value them for less than the ESO might be economically worth to others. Further, employees may exercise their vested ESOs early because they cannot sell or transfer them. This early exercise behavior is not “optimal” from a risk-neutral option valuation perspective, but is rational as employees seek to optimize their less diversified/risk averse utility.

Although ESOs are valued by employees, they are probably valued at less than their economic worth by employee holders. Employees tend to value their options for what they would get for them by exercising them (i.e., their “intrinsic” value) and not the higher theoretical option value.

As stated, ESOs are generally granted with vesting restrictions and prohibitions on transfer. Typically the issuing company board of directors controls transferability, and limited transferability is often allowed for estate purposes (gifting or transfer of ESO to a family trust or family member). However the ESOs are still subject to vesting restrictions, and lapse rules (or if lapse rules have been removed, then claw-back provisions against the employee if they leave within a specified time period). In a small number of circumstances, some companies may allow senior executives to transfer ESOs to a “exchange fund” partnership to diversify their ESO positions.

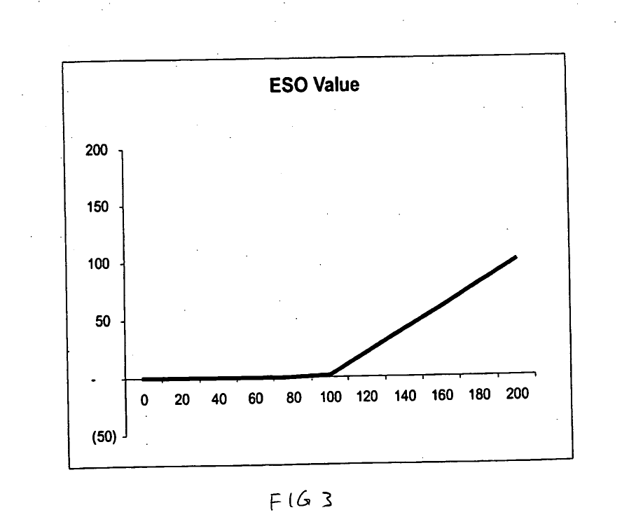

An option is “underwater” or “out-of-the-money” when the stock price is below the option exercise or strike price, and ESOs tend to lose their incentive or motivational impact when they are underwater. The loss in incentive results from the fact that employees can only exercise (not sell or transfer) their options, and thus when the option is underwater, it has limited or no value to the employee. In fact, deep underwater options can be demotivating, because the likelihood of payout is quite low. Referring to FIG. 3, the value of an ESO with a strike price of $100 is illustrated with the stock price of the underlying stock on the horizontal axis. When the stock price is less than the strike price of $100, the option is underwater, and has no value upon exercise.

To address these problems, companies have attempted to manage their underwater ESO exposure by: 1) restriking down the option exercise price; 2) canceling awards and awarding new grants; 3) accelerating new grants; and 4) tendering for the underwater options (for cash or stock). However, these one-time fixes can create adverse stockholder reaction.

There are a number of reasons why companies have not granted broadly transferable ESOs, and one reason is that the U.S. tax code seems to suggest that granting transferable stock options is taxable upon grant. Section 83 of the U.S. tax code states that options that have “readily ascertainable fair market value” are taxable upon grant. In contrast, current tax treatment of non-transferable ESOs suggests that the grant is non-taxable and only the exercise or sale of the ESO is a taxable event. For a number of reasons, most employers and employees don't want to have the grant of the ESO to be a taxable event.

Options and warrants are different, and companies grant warrants to investors, business partners, and lenders, which are generally transferable under applicable SEC exemptions (registration, private placement, etc.). These warrants are exercisable under their terms and generally do not lapse. These warrants are sold for cash or issued as part of an exchange for goods or services.

Transferable stock options can be priced using an option pricing model and risk-neutral pricing theory. The lack of transferability and required lapse upon termination of employment motivate employees to exercise their ESOs early, which is also suboptimal from a theoretical risk neutral valuation perspective.

An Example System

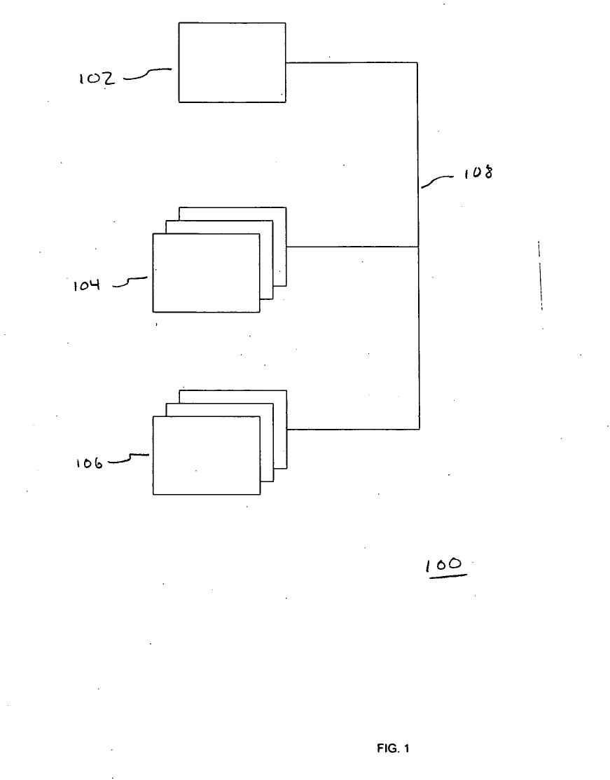

Referring to FIG. 1, an example system 100 according to one embodiment includes a company 102 that issues options on company stock to employees 104. System 100 also includes a market 106 where third-party purchasers or bidders can purchase the ESOs. Although not illustrated, company 102, employees 104 and market 106 include computers with central processor units (CPUs), volatile and non-volatile memory (RAM, ROM, EPROM, flash, etc.), fixed and removable code storage devices (floppy drives, hard drives, memory sticks, tape, CD, DVD, etc.), input/output devices (keyboards, display monitors, printers, pointing devices, etc.), and network interface devices (Ethernet cards, WiFi cards, modems, etc.). Company 102, employees 104 and market 106 are interconnected by network 108, which may be a LAN, WAN, intranet, extranet, the Internet, the PSTN, etc. Computer executable software code is stored on the fixed and removable code storage devices, and is also transferred as an information signal, such as by download.

An Example Method

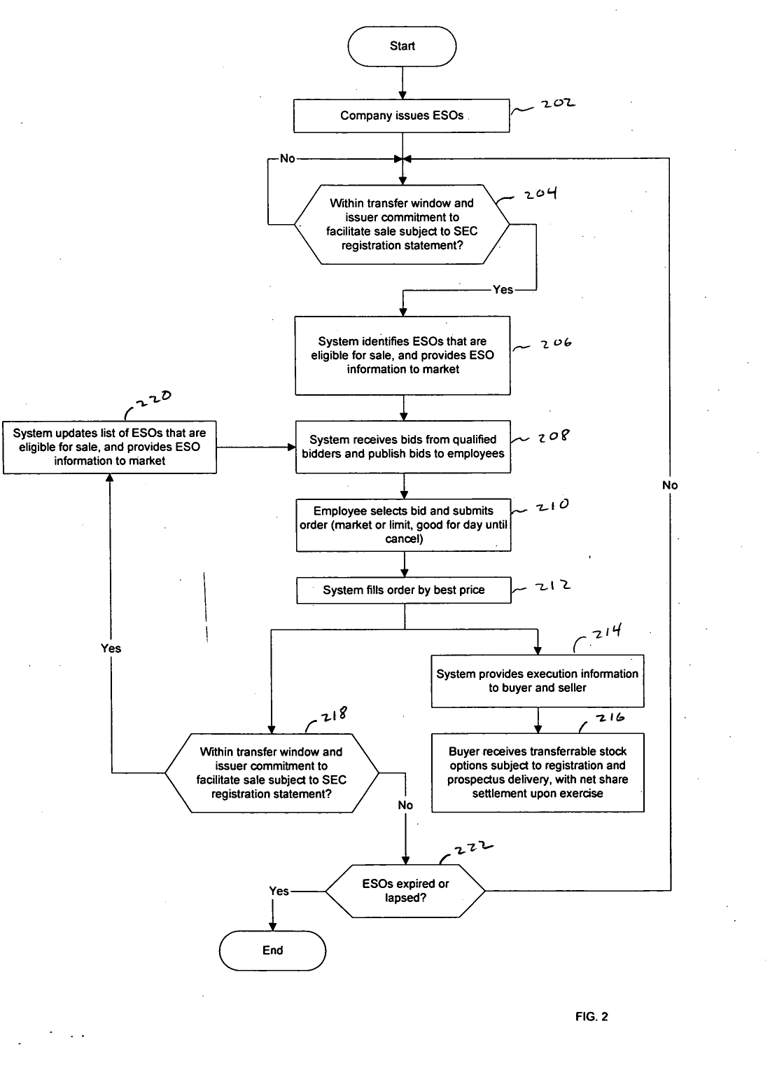

Referring to FIG. 2, at step 202, company 102 issues options on company stock (ESOs) to employees 104. In one embodiment, the ESOs have a strike price, a maturity data and a restriction on transfer.

At step 204, system 100 determines whether a predetermined transfer window is active, and whether issuer 102 has made a commitment to facilitate sale or transfer of the ESOs subject to an effective SEC registration statement and prospectus delivery for the sale. In one embodiment, the transfer window is as short as two weeks, or as long as four weeks. In one embodiment, the transfer window occurs periodically through the year, such as each quarter, or each six months. The first transfer window typically occurs at least one year after issue of the ESOs, or coincides with the first vesting date of the ESOs. In one embodiment, system 100 indicates that a predetermined transfer window is active and that there is a commitment to facilitate sale or transfer of the ESOs by displaying a flag or text on a Web interface that is used by employee 104.

If at step 204 system 100 determines that no transfer window is active, or that issuer 102 has not made a commitment to facilitate sale or transfer of ESOs subject to SEC registration and prospectus delivery, then system 100 loops to step 204.

If at step 204 system 100 determines that a predetermined transfer window is active, and that issuer 102 has made a commitment to facilitate sale or transfer of ESOs subject to an SEC registration and prospectus delivery, then at step 206 system 100 identifies the ESOs that are eligible for sale or transfer and provides information on those ESOs to market 106. In one embodiment, only vested ESOs are eligible for sale or transfer. In one embodiment, the information that is provided to market 106 includes the strike price, the maturity date and the numbers of options at the strike price.

At step 208, system 100 receives bids from qualified bidders in market 106, and publishes the bids to employees 104. In one embodiment the bids are published using a Web interface that also shows the individual employee's ESO holdings, including vested and unvested ESOs. The published bids may also show highest bid, size of bid and other market information, such as depth of market and minimum price.

If employee 104 decides to sell or transfer some or all of their ESOs, then at step 210 employee 104 submits an order to sell or transfer with an indication of the number of ESOs to sell or transfer. In one embodiment, the order is a market order to sell. In another embodiment, the order is a limit order. In one embodiment, the order is good for the day or until cancelled.

System 100 receives the order from employee 104, and at step 212, fills the order at the best price by matching the employee order with bids from market 106. In one embodiment, system 100 fills the order in priority by the highest price instead of by sale order type, such as market order, or limit order.

At step 214, system 100 provides order execution information to employees 104 and the winning bidder.

At step 216, the winning bidder receives transferable stock options subject to an effective SEC registration statement and prospectus delivery. This sale-or transfer subject to an effective SEC registration statement and prospectus delivery allows the winning bidder to hedge without restriction. In one embodiment, the transferable stock options include a provision for net share settlement by the winning bidder upon exercise, which allows the winning bidder to receive clean shares upon exercise. Although not illustrated, the winning bidder also receives the prospectus.

There are at least two ways the ESO can be sold or transferred to the winning bidder. In one, the ESO is sold or transferred from the employee to the winning bidder, and the issuing company provides the effective registration statement and prospectus for the sale. In another, the employee surrenders their ESO to the issuing company, which issues a different, but transferable, stock option to the winning bidder.

Proceeds from the sale or transfer are provided to the employee, taking into account any required tax or other withholdings. When the ESO is sold or transferred by the employee to the winning bidder, the registration statement covers the sale of the option to the third party winning bidder. When the ESO is surrendered to the company and the company issues transferable stock options to the third party winning bidder, the registration statement applies to the common stock underlying the options and is used by the third party winning bidder in the case where they hedge using the registration statement.

At step 218, system 100 determines whether the predetermined transfer window is still active, and whether issuer 102 has continued to make a commitment to facilitate sale or transfer of ESOs subject to an effective SEC registration statement and prospectus delivery for the sale. If so, then at step 220, system 100 updates the ESOs that are eligible for sale or transfer and provides the updated information to market 106.

If at step 218 system 100 determines that the predetermined transfer window is no longer active, or that issuer 102 is no longer going to make a commitment to facilitate sale or transfer of ESOs subject to an effective SEC registration statement and prospectus delivery for the sale, then at step 222, system 100 determines whether all ESOs have expired or lapsed and if so ends. If not, system 100 loops to step 204.

In order for a company to implement the embodiments described above, they can amend an existing ESO plan to allow for transferability for certain tranches or classes of ESOs that have already been granted. This might involve the Board of Directors amending the plan to allow the employees to sell their ESOs. It is also possible that the embodiments are applied to new ESO grants, where the ESOs are transferable once vested.

In general the embodiments described apply to vested ESOs, and once transferred any lapse restrictions no longer apply.

Although illustrative embodiments have been described herein in detail, it should be noted and will be appreciated by those skilled in the art that numerous variations may be made within the scope of this invention without departing from the principle of this invention and without sacrificing its chief advantages.

Unless otherwise specifically stated, the terms and expressions have been used herein as terms of description and not terms of limitation. There is no intention to use the terms or expressions to exclude any equivalents of features shown and described or portions thereof and this invention should be defined in accordance with the claims that follow.

1. A method for sale or transfer of employee stock options, the method comprising:
providing options to an employee on stock of an issuing company at a first time, the options comprising at least a strike price, a maturity date, a vesting requirement and a restriction on transfer; and
providing a registration statement and a prospectus at a second time that is after the first time, the registration statement and the prospectus covering sale or transfer of the options from the employee to a third party.

2. A method according to claim 1, further comprising:
providing information on the options to bidders in a market, the information comprising strike price, maturity date and number of options.

3. A method according to claim 1, further comprising:
receiving bid information on the options; and
making the bid information available to the employee.

4. A method according to claim 3, wherein the bid information comprises price.

5. A method according to claim 3, wherein the bid information comprises size.

6. A method according to claim 3, wherein the bid information comprises market depth.

7. A method according to claim 1, further comprising:
receiving an order from the employee to sell or transfer at least some of the options;
executing at least part of the order; and
providing order execution information to the employee.

8. A method according to claim 7, wherein the order is a market order to sell.

9. A method according to claim 7, wherein the order is a limit order to sell.

10. A method according to claim 7, wherein the order comprises number of options to sell.

11. A method according to claim 7, wherein executing the order is in priority by price.

12. A method according to claim 1, further comprising:
maintaining information on the options;
selling or transferring some of the options to the third party; and
updating the information on the options after the employee sells or transfers some of the options.

13. A method according to claim 12, wherein the information on the options comprises number of vested options and strike prices of the options.

14. A method according to claim 1, further comprising:
delivering the prospectus to the third party.

15. A method according to claim 1, further comprising:
providing information to the employee on options held by the employee.

16. A method according to claim 1, further comprising:
providing information to the employee on options eligible for sale or transfer by the employee.

17. A method according to claim 1, further comprising:
receiving at least some of the options from the employee; and
providing transferable stock options to the third party.

18. A method according to claim 1, further comprising:
selling or transferring at least some of the options to the third party;
withholding tax from proceeds of the sale or transfer; and
providing a balance to the employee in cash or shares.

19. A method according to claim 1, further comprising:
amending terms of previously issued options to allow sale or transfer of the previously issued options to the third party.

20. A method according to claim 1, wherein the options further comprise a lapse restriction, the method further comprising:
removing the lapse restriction after sale or transfer of the options to the third party.

21. A method according to claim 1, wherein the registration statement is a Securities and Exchange Commission registration statement.

22. A method according to claim 1, wherein the options include a provision for net share settlement upon exercise by the third party.

23. A method according to claim 1, wherein the registration statement and prospectus cover options sold or transferred to the third party.

24. A method according to claim 1, wherein the registration statement and prospectus cover common stock sold or transferred to the third party and underlying the options.

25. A method for sale or transfer of employee stock options, the method comprising:
providing options to an employee on stock of an issuing company at a first time, the options comprising at least a strike price, a maturity date, a vesting requirement and a restriction on transfer;
maintaining information on the options, the information on the options comprising number of options and strike prices of the options;
providing information on the options to bidders in a market, the provided information comprising the strike price, the maturity date and the number of options;
receiving bid information on the options from the bidders in the market;
making the bid information available to the employee, wherein the bid information comprises size and price;
receiving an order from the employee to sell or transfer at least some of the options;
providing an effective Securities and Exchange Commission registration statement at a second time that is after the first time, the registration statement covering sale or transfer of the options to a third party;
executing at least part of the order;
providing order execution information to the employee;
transferring the options to the third party;
updating the information on the options; and
delivering a prospectus to the third party covering the options.

26. A method for sale or transfer of employee stock options, the method comprising:
providing options to an employee on stock of an issuing company at a first time, the options comprising at least a strike price, a maturity date, a vesting requirement and a restriction on transfer;
maintaining information on the options, the information on the options comprising number of options and strike prices of the options;.
providing information on the options to bidders in a market, the provided information comprising the strike price, the maturity date and the number of options;
receiving bid information on the options from the bidders in the market;
making the bid information available to the employee, wherein the bid information comprises size and price;
receiving an order from the employee to sell or transfer at least some of the options;
providing an effective Securities and Exchange Commission registration statement at a second time that is after the first time, the registration statement covering common stock sold or transferred to a third party and underlying the options;
executing at least part of the order;
providing order execution information to the employee;
providing transferable stock options to the third party;
updating the information on the options; and
delivering a prospectus to the third party covering common stock sold or transferred and underlying the options.

27. A system for sale or transfer of employee stock options, comprising:
means for providing options to an employee on stock of an issuing company at a first time, the options comprising at least a strike price, a maturity date, a vesting requirement and a restriction on transfer; and
means for providing a registration statement and a prospectus at a second time that is after the first time, the registration statement and the prospectus covering sale or transfer of the options from the employee to a third party.

28. A computer-readable medium having computer executable software code stored thereon, the code for sale or transfer of employee stock options, the code comprising:
code to provide options to an employee on stock of an issuing company at a first time, the options comprising at least a strike price, a maturity date, a vesting requirement and a restriction on transfer; and
code to provide a registration statement and a prospectus at a second time that is after the first time, the registration statement and the prospectus covering sale or transfer of the options from the employee to a third party.

29. Computer executable software code transmitted as an information signal, the code for sale or transfer of employee stock options, the code comprising:
code to provide options to an employee on stock of an issuing company at a first time, the options comprising at least a strike price, a maturity date, a vesting requirement and a restriction on transfer; and
code to provide a registration statement and a prospectus at a second time that is after the first time, the registration statement and the prospectus covering sale or transfer of the options from the employee to a third party.

30. A programmed computer for sale or transfer of employee stock options, comprising:
a memory having at least one region for storing computer executable program code; and
a processor for executing the program code stored in the memory; wherein the program code comprises:
code to provide options to an employee on stock of an issuing company at a first time, the options comprising at least a strike price, a maturity data, a vesting requirement and a restriction on transfer; and
code to provide a registration statement and a prospectus at a second time that is after the first time, the registration statement and the prospectus covering sale or transfer of the options from the employee to a third party.
